(19) United States
(12) Patent Application Publication
(10) Pub. No.: US 2008/0253601 A1
(43) Pub. Date: Oct. 16, 2008

(54) Microphone Stand

(75) Inventor: David Hilderman, Victoria (CA)

Correspondence Address: CANTOR COLBURN, LLP, 20 Church Street, 22nd Floor, Hartford, CT, 06103, US

(73) Assignee: THE TC GROUP A/S, Risskov (DK)

(21) Appl. No.: 12/089,508

(22) PCT Filed: Oct. 7, 2005
(86) PCT No.: PCT/DK2005/000645

§ 371 Date: Jun. 12, 2008

(51) Int. Cl. H04R 1/02

(52) U.S. Cl. 381/363

(57) ABSTRACT

The present invention relates to a microphone stand comprising an upper assembly (4) and a support portion (2), said upper assembly (4) comprising at least one loudspeaker (5) and at least one microphone boom (6), said at least one loudspeaker (5) and said at least one microphone boom (6) being mutually fixed, said upper assembly being attached to said support portion (2) by means of at least one rotary joint (7; 41,42; 43; 44).

### FIELD OF THE INVENTION

The invention relates to a microphone stand according to the provisions of claim 1.

### BACKGROUND OF THE INVENTION

The present invention relates to sound monitors used by performers, mainly vocalists, on stage. The monitor is a speaker cabinet with at least one speaker inside the cabinet. The monitor's purpose allows an individual performer to monitor a mixture of instruments and voice on stage during the performance. On stage, the mixture of instruments and voice is usually controlled by a sound person using a mixing console. The sound heard by the audience is known as the main mix. The mix of at least the vocal mix is amplified back on stage through the monitor. Usually, each performer has an individual monitor unit for their own use for monitoring their own performance. The typical monitor employed is a floor monitor. The floor monitor is a floor-mounted speaker cabinet with at least one speaker inside. The floor monitor is usually placed angled slightly upward and in front of the performer and his microphone stand. The sound from the floor monitor usually must travel from seven to fifteen feet before reaching the performer. The stage tends to have a very high ambient noise level during a performance due to all the instruments; hence the performer usually requires the output volume of the monitor to be very loud in order to cut through the stage noise and the main mix. On smaller stages, such as nightclubs, the main mix can be overpowered by the sound from the floor monitors. Also, the floor monitors take up the limited floor space on stage. The product described herein has the intended use for a vocal-monitoring loudspeaker system that is designed to be not only floor mounted, but also with the unique ability to be integrated into the microphone boom stand, and when the microphone's position is moved, the audio output from the monitor tracks the microphone's position of horizontal axis to said user.

U.S. Pat. No. 6,487,298 discloses an arrangement comprising both a microphone stand and a monitor. A problem of the disclosure related to U.S. Pat. No. 6,487,298 is that the speaker remains static or uncontrolled when the microphone is moved horizontally or vertically.

### SUMMARY

The present invention relates to a microphone stand comprising an upper assembly (4) and a support portion (2), said upper assembly (4) comprising at least one loudspeaker (5) and at least one microphone boom (6), said at least one loudspeaker (5) and said at least one microphone boom (6) being mutually fixed, said upper assembly being attached to said support portion (2) by means of at least one rotary joint (7; 41,42; 43; 44).

The loudspeaker and the microphone boom are mutually fixed in the sense that the microphone boom is either integrated with the loudspeaker arrangement or more preferably fastened by a non-permanent fixation.

The microphone boom may be fixed to the loudspeaker by means of clamping, fastened by screws, welding or any suitable fastening. Obviously, a non-permanent secure fixation is preferred.

The term rotary joint should be understood broadly as an arrangement which may comprise one single joint, an assembly of joints or even a joint where the coupling between the two joined portions is enabled by gravity. Evidently, the term joint may also include the more traditional meaning of two parts which are actually held together.

Thus, the upper assembly may both be attached to the support portion by a permanent joint or simply positioned and maintained in position by means of gravity.

Generally, the rotary joint may be adapted for e.g. stepwise rotation, frictional rotation, unrestricted rotation or electrically controlled rotation.

In an embodiment of the invention, the support portion comprises a supporting arrangement (2) supporting a shaft (3).

In an embodiment of the invention, the at least one rotary joint (7) defines a movement restricted to one degree of freedom, said one degree of freedom defining rotation around an axis which is substantially coincident with the axis of the shaft (3).

In an embodiment of the invention, the at least one rotary joint (7) defines the rotation of the upper assembly.

In an embodiment of the invention, the at least one rotary joint (7) defines the rotation of the upper assembly (4) around the axis of the shaft.

In an embodiment of the invention, the at least one rotary joint (7) comprises a joint (43) where the upper assembly (4) and the support portion or at least a part thereof are held together.

In an embodiment of the invention, the at least one rotary joint (7) comprises a joint (44) where the upper assembly (4) rests for a rotation.

In an embodiment of the invention, the positioning and the orientation of the at least one rotary joint (7) defines the position of the center of gravity (CG) of the upper assembly (4) when the assembly (7) is rotated.

In an embodiment of the invention, the center of gravity of the upper assembly (4) is substantially fixed when the upper assembly (4) is rotated.

In an embodiment of the invention, the upper assembly (4) comprises two or further rotary joints.

According to an advantageous embodiment of the invention, three or more rotary joints should be predefined and available upon choice by the user.

According to an embodiment, the upper assembly comprises two or further rotary joints which may define different rotation axes of the upper assembly, but still ensure that the center of gravity is substantially maintained, at least enough to keep the complete microphone in balance at the default position and when rotated.

In an embodiment of the invention, at least one loudspeaker (5) and at least one microphone boom (6) are mutually fixed by an attachment arrangement (8).

The microphone boom may be fixed to the loudspeaker by means of an attachment arrangement comprising clamping, screwing, welding or any suitable fastening. Obviously, a non-permanent secure fixation is preferred.

According to an embodiment of the invention, movement of the microphone boom results in a corresponding movement of the loudspeaker at least with respect to rotation around the vertical axis of the shaft of the microphone stand. According to a preferred embodiment of the invention, the loudspeaker should preferably track the movement of the microphone stand both with respect to rotation and inclination.

In an embodiment of the invention, the loudspeaker rotates with the microphone boom (6).

In an embodiment of the invention, the center of gravity (CG) is located on or very near the axis of rotation of the rotary joint, thereby obtaining that the moment of the forces in the transverse direction is minimized.

In an embodiment of the invention, the center of gravity (CG) is located on or in the vicinity of the axis of rotation of the rotary joint.

In a preferred embodiment of the invention the center of gravity (CG) of the upper assembly is determined on the basis of the non-microphone boom parts of the upper assembly.

Evidently, the center of gravity may be determined on the basis of the complete upper assembly, microphone boom and microphone included, within the scope of the invention. According to a preferred embodiment, however, the center of gravity should be determined on the basis of the non-microphone boom parts of the upper assembly; i.e. without considering the influence of the microphone boom.

An advantage of doing so is that the microphone stand typically is pre-designed per se to keep balance when holding microphones in different positions and that the most ideal balancing of the upper assembly would typically be to keep the balance of the added part neutral. This may be done by considering the center of gravity of the non-microphone boom parts of the upper assembly only.

It is noted that the main contributing non-microphone boom part of the upper assembly may typically be constituted by the loudspeaker and the associated circuitry.

Another advantage of considering the center of gravity of the non-microphone boom parts only, is that adjustment—e.g. rotation or inclination—would add no further instability to the complete setup than such adjustment would do to a conventional microphone stand comprising a microphone.

According to further embodiment of the invention another aspect that is significant is that the axis of rotation of the rotary joint is nearly perfectly vertical (as vertical as an off-the-shelf microphone stand can be). A completely vertical axis is beneficial in the case where the center of gravity for some reason is not perfectly in line with the axis of rotation.

### FIGURES

The invention will now be described with reference to the drawings of which

FIG. 1 illustrates a microphone stand according to an embodiment of the invention,

FIGS. 2A and 2B illustrate two different loudspeaker mountings of a microphone stand according to an embodiment of the invention,

FIG. 3A-3C illustrate the position of the center of gravity when the upper assembly is rotated.

FIG. 4A-4C illustrate different embodiments of rotary joints within the scope of the invention and where

FIGS. 5A and 5B illustrate a further embodiment of the invention.

### DETAILED DESCRIPTION

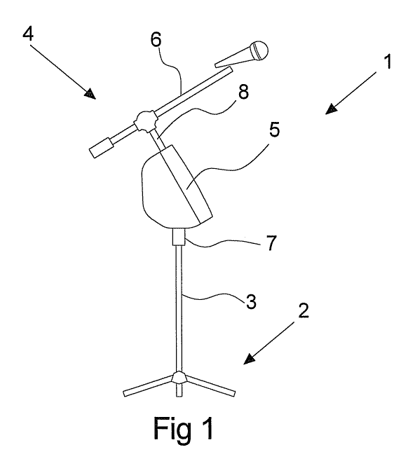

FIG. 1 illustrates a preferred embodiment of the invention.

A microphone stand 1 comprises a supporting arrangement 2 fixed to a shaft 3. An upper end of the shaft 3 supports an upper assembly 4 by means of a rotary joint 7. The upper assembly comprises a loudspeaker 5 and a microphone boom 6. The microphone boom 6 is fixated to the loudspeaker 5 by an attachment arrangement 8.

The microphone boom may preferably be fixed to the loudspeaker 5 in a secure way, ensuring that the loudspeaker 5 rotates with the microphone boom 6, when the boom is rotated.

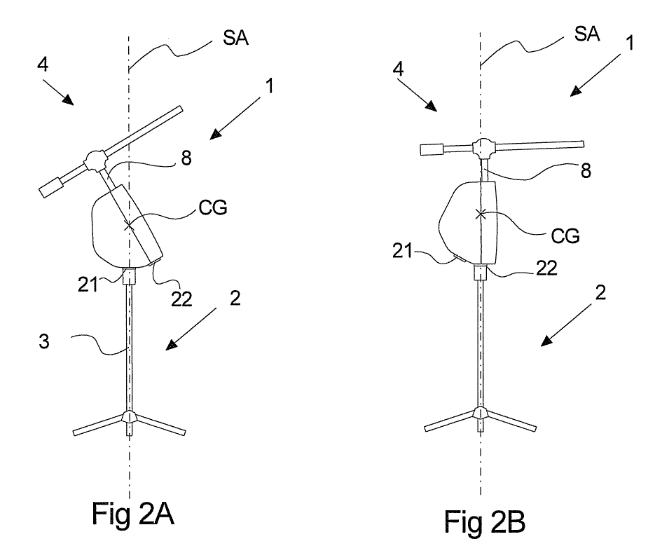

FIGS. 2A and 2B illustrate a further feature of an embodiment of the invention, namely the tracking of the microphone boom by the loudspeaker.

Thus, FIG. 2A illustrates a further embodiment of the invention which basically corresponds to FIG. 1, but now provided with a two-point rotary joint arrangement 21, 22.

A user may basically decide when the upper assembly 4 should be joined to the support portion 2 by means of rotary joint part 21 or rotary joint part 22.

It is noted that the attachment arrangement 8 ensures that the loudspeaker of the upper assembly tracks the microphone boom when the microphone boom is inclined as illustrated in FIG. 2A or when kept in the horizontal position as illustrated in FIG. 2B.

It is furthermore noted that the specific use of pre-positioned and pre-oriented joint parts 21 and 22 ensure that the center of gravity CG of the upper arrangement is kept substantially coincident with the axis SA of the shaft 3 or at least sufficiently coincident to keep the microphone stand in balance when inclining the upper assembly.

The pre-oriented joint parts 21 and 22 may either be fitted to the upper part of the shaft and form part of two principally different rotary joints.

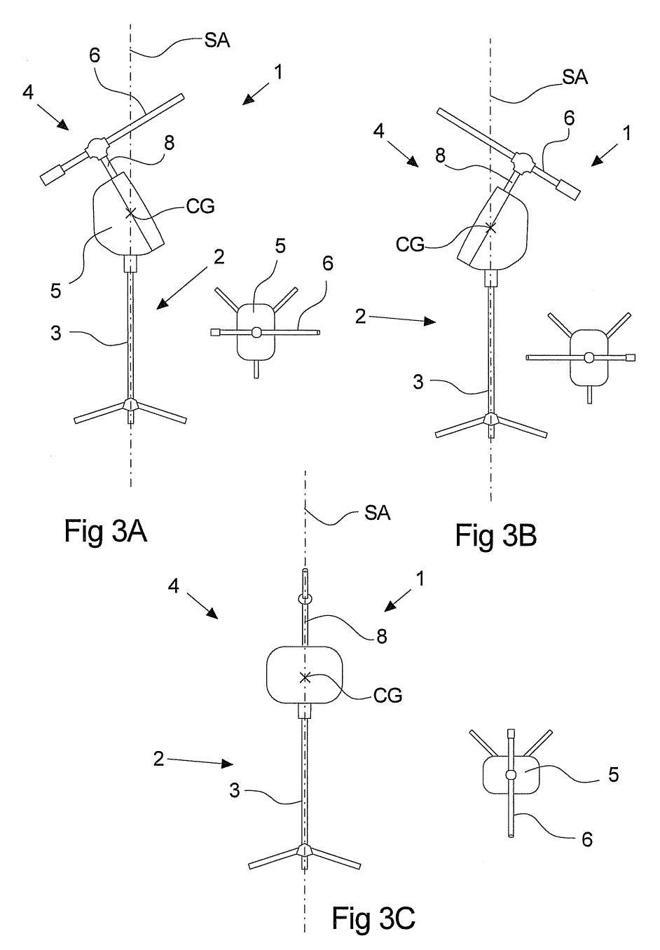

FIG. 3A-3C illustrate a further feature of the microphone stand illustrated in FIGS. 2A and 2B.

According to a preferred embodiment of the invention a rotary joint facilitates balancing of the upper assembly when the upper assembly 4 is rotated along the vertical axis SA.

Thus, when designing the illustrated embodiment of the invention, center of gravity should be located on or very near the axis of rotation SA of the rotary joint at any point of rotation along the vertical axis SA, thereby obtaining that the moment of the forces in the transverse direction is minimized and preferably unchanged during rotation.

Thus, as it will be illustrated by the three figures, center of gravity CG will be kept substantially fixed with respect to the shaft axis SA, thereby improving the balance of the complete microphone stand.

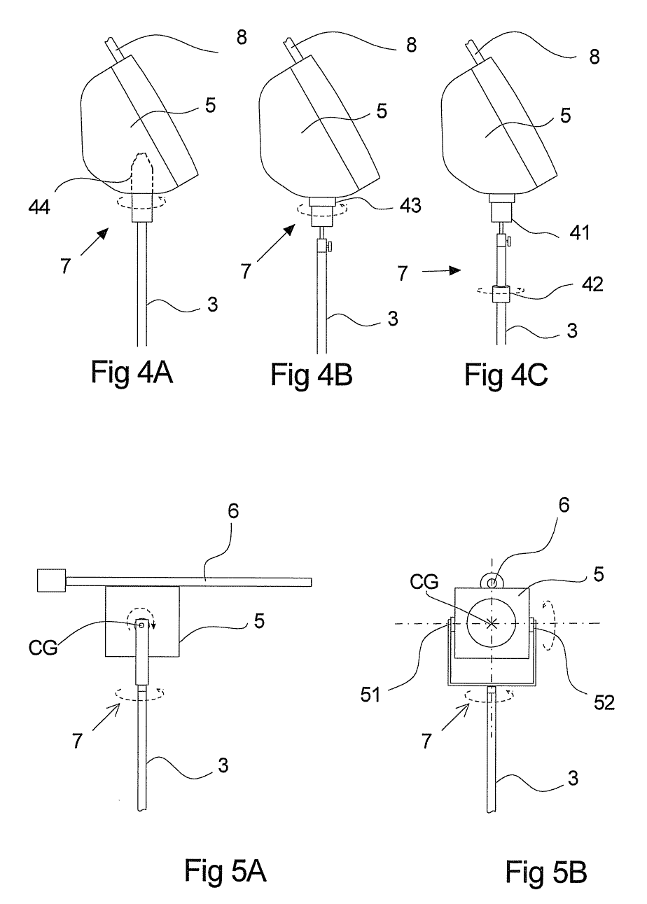

FIG. 4A-4C illustrate different embodiments of rotary joints within the scope of the invention.

The illustrated rotary joint 7 of FIG. 4A both enables rotation around the axis of the support shaft and forms a support to the upper assembly 4.

As illustrated, the rotary joint 7 of the microphone stand is formed partly by the upper end of the shaft 3 of the support portion which inserts into the bottom of the speaker panel in one 44 of the chosen locations e.g. 21 or 22 as illustrated in FIGS. 3A and 3B, depicting one of two available angles of vertical the axis. It is noted that the upper arrangement may comprise several further inserts in the speaker panel, forming part of several different available rotary joints.

The speaker is then able to rotate on the vertical axis at this gravity-sustained connection.

Different features and provisions of embodiments of the invention will be listed below.

A monitoring loudspeaker system, according to an embodiment of the invention, may comprise means defining a mounting system that is integrated into a microphone boom stand so that when the microphone position on the boom stand is moved, the monitor moves with it and the audio output from the monitor tracks the microphone's position in all directions.

A further embodiment of the invention may include that the monitor tracks the microphone position on the horizontal plane only by rotating around the vertical axis. The monitor rotates as the microphone is rotated on the boom, but maintains a consistent speaker angle.

An advantageous rotary joint may be obtained when the mounting of the monitor on the microphone stand utilizes a cone-shaped attachment which is screwed onto the vertical shaft of the microphone stand. An inverted cone in the negative shape of that attached to the vertical shaft of the microphone stand is on a bottom surface of the monitor. This inverted cone has the same shape as the cone on the microphone stand, except for that the depth extends so that the minimum diameter at the top of the inverted cone is less than the positive cone. The monitor is then placed on the cone so that the inverted cone on the monitor mates with the cone on the stand. The unique function of this is that once placed on the stand, the monitor has absolutely no play in its interface to the microphone stand. Also the monitor can be removed from the stand by simply lifting it off.

A further variant of the above-mentioned embodiment involves that the monitor of the upper arrangement has inverted cones at multiple locations to give various mounting positions on the microphone stand. The monitor is designed so that the locations of these inverted cones are directly below the center of mass of the monitor.

According to a further embodiment of the invention, the mounting of the boom on the monitor is achieved with an attachment that screws into the boom where it normally attaches to the vertical shaft of the microphone stand. This attachment then slides into a slot in the monitor and is held in place by a spring-loaded door. The unique function of this is that the attachment cannot be rotated with respect to the monitor, is easily inserted and removed, and held securely when inserted. It is therefore possible to use other types of joints in this application. People skilled in the said art could use others as required.

FIG. 4B illustrates a further embodiment of the invention where a rotary joint 7 is formed by a more permanent coupling e.g. obtained by screwing the upper assembly directly onto the top of a conventional microphone shaft 3. In this embodiment, the rotary joint comprises a rotary coupling 43 keeping the upper assembly together with the support portion for other movements than rotation around the axis of the shaft.

FIG. 4C illustrates a further embodiment of the invention comprising a rotary joint 7 which is somewhat distributed, still obtaining the important features of the invention.

According to the illustrated embodiment, the rotary joint 7 comprises an upper part 41 which is rigidly fixed to the loudspeaker 5 of the upper assembly. According to the illustrated embodiment, the orientation relative to the center of gravity of the loudspeaker 5 of the upper assembly is primarily obtained and defined by the position and orientation of the rotary joint 41 on the upper assembly 4 whereas the intended rotation is obtained through a separate rotary coupling 42 mounted on the upper part of the shaft 3 of the support portion. In other words, the orientation of the upper assembly and the axis of rotation may be obtained by separate and non-coincident means.

Generally, in the illustrated embodiments of FIG. 4A-C the connection between the upper assembly and the support portion may be based on the already described rotary joint combined with a standard clutch fitting of conventional microphone stands.

FIG. 5A and FIG. 5B illustrates a further embodiment of the invention comprising a lower portion of which only an upper part of the shaft 3 is illustrated.

The upper assembly comprising a loudspeaker 5 having a center of gravity CG and a thereto rigidly fixed microphone boom 6 is coupled to the shaft by means of a rotary joint 7 allowing rotation along a substantially vertical axis. The rotary joint is designed and oriented with respect to the upper assembly to keep the center of gravity CG of the loudspeaker at substantially the same point during rotation.

Moreover, the illustrated embodiment comprises further rotary joint 51 and 52 facilitating rotation along a horizontal axis. The rotary joints 51 and 52 are moreover oriented and positioned to maintain the center of gravity of the loudspeaker 5 at the same position during rotation along the horizontal axis. In other words, an advantageous embodiment of the invention comprises means for rotation along more than one axis while maintaining the center of gravity neutral with respect to balancing of the complete assembly.

1. Microphone stand comprising
an upper assembly and
a support portion
said upper assembly comprising at least one loudspeaker and at least one microphone boom,
said at least one loudspeaker and said at least one microphone boom being mutually fixed,
said upper assembly being attached to said support portion by means of at least one rotary joint.

2. Microphone stand according to claim 1, wherein the support portion comprises a supporting arrangement supporting a shaft.

3. Microphone stand according to claim 1, wherein the at least one rotary joint defines a movement restricted to one degree of freedom, said one degree of freedom defining rotation around an axis which is substantially coincident with the axis of the shaft.

4. Microphone stand according to claim 1, wherein the at least one rotary joint defines the rotation of the upper assembly.

5. Microphone stand according to claim 1, wherein the at least one rotary joint defines the rotation of the upper assembly around the axis of the shaft.

6. Microphone stand according to claim 1, wherein the at least one rotary joint comprises a joint where the upper assembly (4) and the support portion or at least a part thereof are held together.

7. Microphone stand according to claim 1, wherein the at least one rotary joint comprises a joint where the upper assembly rests for a rotation.

8. Microphone stand according to claim 1, wherein the positioning and the orientation of the at least one rotary joint defines the position of the center of gravity (CG) of the upper assembly when the assembly is rotated.

9. Microphone stand according to claim 1, wherein the center of gravity of the upper assembly is substantially fixed when the upper assembly is rotated.

10. Microphone stand according to claim 1, wherein the upper assembly (4) comprises two or further rotary joints.

11. Microphone stand according to claim 1, wherein said at least one loudspeaker and at least one microphone boom are mutually fixed by an attachment arrangement.

12. Microphone stand according to claim 1, wherein the loudspeaker rotates with the microphone boom.

13. Microphone stand according to claim 1, wherein the rotary joint is located beneath the center of gravity (CG).

14. Microphone stand according to claim 1, wherein the center of gravity (CG) is located on or in the vicinity of the axis of rotation of the rotary joint.

15. Microphone stand according to claim 1, wherein the center of gravity (CG) of the upper assembly is determined on the basis of the non-microphone boom parts of the upper assembly.

16. Microphone stand according to claim 1, wherein said upper assembly is attached to said support portion by means of at least one, preferably at least two rotary joints allowing rotation with respect to at least two different axes having non-coincident orientation.
